(19) United States
(12) Patent Application Publication
(10) Pub. No.: US 2023/0347285 A1
(43) Pub. Date: Nov. 2, 2023

(54) REMOVAL OF AIRBORNE OXIDES AND CONVERSION OF COMPOUNDS IN GASES INTO ELEMENTAL SUBSTANCES

(71) Applicant: RAIN CAGE CARBON, INC., Calgary (CA)

(72) Inventors: Mark Fertman, North York (CA); Blair Aiken, Calgary (CA); Gerard Campeau, Newmarket (CA); Debbie Maguire, Evansville, IN (US)

(21) Appl. No.: 18/309,866

(22) Filed: May 1, 2023

Related U.S. Application Data
(60) Provisional application No. 63/337,255, filed on May 2, 2022.

(51) Int. Cl. B01D 53/32; B01D 53/62

(52) U.S. Cl. CPC B01D 53/326; B01D 53/62; B01D 2257/502; B01D 2257/504

(57) ABSTRACT

An apparatus, system and methods are described in which articulates and/or oxide compounds are removed from a fluid medium, where at least some of the oxide compounds are converted to elemental and/or allotropic substances and can be collected for use in further applications.

### CROSS-REFERENCE TO RELATED APPLICATION

This application claims priority from U.S. Provisional Patent Application Ser. No. 63/337,255, filed May 2, 2022, the disclosure of which is incorporated herein by reference in its entirety.

### FIELD OF THE INVENTION

The present invention relates to processing of industrial emissions, combustion gases, atmospheric gases, and other gaseous or liquid fluids (e.g., water) to remove contaminants and/or nano particulates, and cause disassociation of pollutants present in the form of oxides, as a method for the simultaneous production of allotropes, and other elemental materials and emissions treatment.

### BACKGROUND

Atmospheric and ambient environments have become increasingly contaminated due to a variety of different natural phenomena and due to the introduction of man-made pollutants into the air and water by industrial nations around the globe. Common examples of man-made pollutants introduced into the air include airborne compounds (e.g., gases and/or particulates) produced by combustion in hydrocarbon-burning power plants, incinerators, industrial processes of various kinds like smelting operations, nitric and sulfuric acid plants, internal combustion engines, etc. For the most part, such pollutants comprise oxidation products of carbon, sulfur, nitrogen, lead, zinc, and other elements. For example, since coal includes traces of various impurities, including lead, zinc, silver, etc., when coal is burned the carbon in the coal as well as these impurities are oxidized. The sulfur oxides and nitrogen oxides produced from the combustion of fuels containing sulfur compounds and the combustion of fuels that contain nitrogen compounds form acids that contribute to acid rain, an increasingly significant environmental concern.

Many approaches have been developed for treating the combustion products of hydrocarbon-burning power plants, incinerators, industrial processes, internal combustion engines, etc. to control the introduction of airborne particulates from these sources. For example, coal-burning power plants often employ scrubbing processes that use calcium compounds that react with sulfur oxides to form gypsum. Unfortunately, the substantial amounts of waste products produced by such scrubbing processes present serious disposal problems. Where possible, low-sulfur coals are used in coal-burning power plants to reduce scrubbing requirements, but this increases the costs of power generation. Alternatively, sulfur oxide emissions are reduced by operating the plants at lower temperatures, but this leaves some of the heating value of the coal untapped.

Another approach to treating such emissions has been to use electrostatic precipitators to enhance the removal of particulates, where various types of ionizers are used to create ions that attach themselves to the particulates. The resulting charged particles are then collected in an electrostatic precipitator. However, such processes are unable to capture nano-sized particulate materials (e.g., particles less than 1 micrometer in size).

Unfortunately, prior approaches to controlling the introduction of combustion-produced airborne particulates have met with one or more serious problems. For example, they have not been able to reduce emissions to acceptable levels, they have been inordinately expensive to build or operate, and they have been energy inefficient, and store molecules rather than convert them to useful elemental components.

### SUMMARY OF THE INVENTION

In example embodiments, an apparatus for removing compounds from a fluid medium and converting at least some of the compounds to elemental substances is provided. The apparatus comprises an electrode bed comprising a plurality of conductive electrode needles protruding from a surface of the electrode bed, where the electrode needles are coupled with a voltage source. The apparatus further comprises a water overflow panel spaced from the electrode needles of the electrode bed and including a surface upon which, in operation, water flows, where the electrode needles extend toward the surface of the water overflow panel, and a reaction zone is defined as a space disposed between and separating the surface of the water overflow panel from the electrode needles protruding from the electrode bed. A water supply provides a flow of water into the reaction zone along the surface of the water overflow panel, a fluid supply including an inlet that provides a source fluid including impurities entrained in the fluid into the reaction zone and an exit that facilitates transport of purified fluid from the reaction zone, the purified fluid having less impurities entrained in the purified fluid in relation to the source fluid, and a power source to apply electrical energy to the electrode needles at a pulse frequency of greater than 24,000 Hertz (Hz) and a negative voltage of 30 kilovolts (kV) to 100 kV. In operation in which electrical energy is applied by the power source to the electrode needles, water from the water supply is flowed along the surface of the water overflow panel, and the source fluid is flowed through the reaction zone, impurities entrained in the source fluid are removed and converted to elemental components that become entrained in the water.

In other example embodiments, systems are described herein that include one or a plurality of apparatuses. The apparatuses can be provided in series and/or in parallel in relation to other apparatuses of the system and in relation to flow of water and/or flow of source fluid through the apparatuses within the system.

In further example embodiments, methods of removing comprising particulates and oxides and dissociating oxides from a fluid medium and converting the oxides into elemental and/or allotropic substances is provided as shown and described herein.

For example, a method of removing compounds from a fluid medium and converting at least some of the compounds to elemental substances comprises directing water to flow along a surface of a water overflow panel within an apparatus, applying electrical energy to a plurality of conductive electrode needles protruding from a surface of an electrode bed, where the electrode bed is aligned with the water overflow panel such that the electrode needles extend toward the surface of the water overflow panel, and a reaction zone is defined as a space disposed between and separating the surface of the water overflow panel and the electrode needles protruding from the electrode bed, and directing a source fluid into the reaction zone defined between the surface of the water overflow panel and the electrode needles protruding from the electrode bed while electrical energy is applied at a pulse frequency of greater than 24,000 Hertz (Hz) and a negative voltage of 30 kilovolts (kV) to 100 kV to the electrode needles so as to remove impurities entrained in the source fluid and convert the removed impurities to elemental components that become entrained in the water flowing along the surface of the water overflow panel.

The above and still further features and advantages of the present invention will become apparent upon consideration of the following detailed description of specific embodiments thereof.

### BRIEF DESCRIPTION OF THE DRAWINGS

FIG. 1 is a view in perspective of an apparatus in partial perspective as described herein.

FIG. 2 is a side view of the apparatus of FIG. 1.

FIG. 3 is an exploded side view of the apparatus of FIG. 1.

FIG. 4 is a view of a sidewall portion of the apparatus including an electrode bed and corresponding waterflow overflow panel.

FIG. 5 is a view of a planar reaction surface for an electrode bed for the apparatus of FIG. 1 including a plurality of electrodes.

FIG. 6 is a first side view in partial section of a system including a plurality of apparatuses as depicted in FIG. 1.

FIG. 7 is a partial and enlarged view in perspective and in partial section of the first side of the system of FIG. 6.

FIG. 8 is a partial and enlarged view in perspective and in partial section of a second side (which opposes the first side) of the system of FIG. 6.

Like reference numerals have been used to identify like elements throughout this disclosure.

### DETAILED DESCRIPTION

In the following detailed description, reference is made to the accompanying figures which form a part hereof wherein like numerals designate like parts throughout, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that any discussion herein regarding “one embodiment”, “an embodiment”, “an exemplary embodiment”, and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The terms “comprising,” “including,” “having,” and the like, as used with respect to embodiments of the present disclosure, are synonymous.

Described herein are an apparatus, a system and methods of producing elemental materials (including fullerenes and other nano-sized materials or materials having particulate sizes of no greater than 1 micrometer) including, without limitation, engineered partially functionalized elemental materials, utilizing fluids such as liquids (e.g., water), emissions gases, atmospheric or environmental gases, such as feedstock, and any combinations of gaseous and liquid fluids (e.g., contaminated water combined with polluted air). For example, the feedstock can comprise a fluid medium such as a gas, a liquid, or a combination of a gas with a liquid. More particularly, described herein are an apparatus, a system and methods for treating in an electrochemical and/or electrophysical process an air flow containing pollutants generated from the burning of fossil fuels, waste, etc., to reduce oxides to solid elemental materials (e.g., nano-sized particulate materials having particle sizes no greater than 1 micrometer) and water, and to remove elemental material from the air flow. The apparatus, system and methods described herein facilitate the recovery from an air flow of useful solid and/or other elemental materials (e.g., nano-sized particular materials) including, without limitation, elemental carbon (including fullerenes), elemental sulfur, elemental iron, elemental gold, elemental magnesium, elemental isotopes, etc., in various forms which also allows for the production of novel products and fuels.

The removal of elemental material from oxide gases and/or particulate combustion products also achieves a filtered, cleansed and greatly improved air quality to the surrounding environment in a highly energy efficient manner. The elemental material that is formed by the embodiments described herein can be nano-sized or, e.g., comprise particulate materials having dimensions of no greater than 1 micrometer in size. In specific applications utilizing the apparatus, system and methods described herein, particulates of sizes less than 5 micrometers, or even particulates no greater than 1 micrometer in size, present in an emission gas can be captured and these particulates can be concentrated into elemental form and separated from the emission gas, allowing for the refining of these compounds. Further, allotropes of elemental materials obtained from the apparatus, system and methods described herein can be selectively formed (e.g., elemental carbon can be formed as graphene, graphite, fullerenes and/or carbon nanotubes of various sizes/carbon numbers, e.g., C₆₀₊, C₇₀₊, etc.).

The gases cleaned by the apparatus, system and methods described herein can be implemented for use in various sectors of the economy including, without limitation, in microbiology, industrial, commercial, and in medical applications.

Methods for cleaning and sterilizing atmospheric air using the apparatus and system can be for domestic premises, medical institutions, schools and preschool organizations. For example, installation of the system and apparatus can be used for cleaning process gases of ferrous and non-ferrous metallurgy, chemistry and petrochemistry, construction industry, energy and fuel industry, for cleaning unorganized emissions of harmful substances in production shops and other premises of enterprises, in industries that dispose of waste by incineration, burning hydrocarbon fuel for technological purposes, for eliminating emissions of pollutants into the atmosphere of boilers running on liquid fuel. The installation can be configured for operation on open production sites, with a prepared concrete base, with utilities and electricity supplied. The use of modular units makes it possible to exclude the construction of a chimney for gas cleaning. The system is further scalable to any volume of emissions.

In accordance with embodiments described herein, the dissociation of oxide compounds (e.g., in gaseous or particulate/solid form) is achieved by cleaning and sterilizing gaseous and/or liquid media with pulsed high-voltage discharge, e.g., pulses greater than 24,000 Hertz (Hz). The high voltage discharge can be generated via electrodes provided in a reaction zone that also comprises a water surface or water interface in contact or communication with an airborne or other gaseous and/or liquid media. The reaction zone can be formed between a precipitation electrode, which is supplied with a continuous stream of water, and an electrode made of electrically interconnected needles, which is supplied with a suitable negative power source, e.g., 30-100 kilovolts (kV) (e.g., 30-80 kV), to achieve the desired dissociation of oxide compounds in the gaseous media into solid and/or other elemental materials and separation of the elemental materials from the gaseous media into the continuous water stream.

The reaction zone can be provided within an apparatus that comprises a housing with pipes for entering and withdrawing a medium to be cleaned and the electrodes for supplying high voltage. One of the electrodes can be made of two planes with water pockets for water overflow, and the second electrode can be made of electrically interconnected needles and connected to a high-voltage power source (where the needles combined collectively to define the electrode). The needles of the second electrode can be fixed on an injector, the surface of which comprises one or more surfaces including, without limitation, one or more flat or planar surfaces, one or more curved (e.g., convex, concave, etc.) surfaces, and surfaces that include planar and curved portions. In the non-limiting example embodiments described herein, the electrode needles are coupled with two planes (or curved surfaces) extending generally vertically within the housing of the apparatus but at a selected angle from the vertical (i.e., vertically being indicated in relation to a height dimension of the housing). The needles can further be installed in a staggered order along a reaction surface of a plane (also described herein as an electrode bed), and the injector can be made of a dielectric material. In addition, as described herein, the needles can be coated with a suitable material to enhance the ionization and oxide dissociation process.

Utilizing the apparatus, system and methods as described herein for extraction and conversion of components in a gaseous media to elemental components is based on the discovery of active factors of electric discharge in the area of the tip of the needles, which determine the course of all physico-chemical processes in gas purification plants, leading to electrochemical and/or electrophysical transformations of components to chemical elements. The process occurring in the near-electrode fouling is believed to be novel and is referred to herein as a plaron reaction. A plaron is a single cycle of states of an interphase transition with the release and absorption of thermal energy. The process associated with the system and apparatus described herein can be characterized as a fast interphase endothermic and exothermic transition reaction occurring with electrical energy applied to the electrode needles at a pulse frequency of greater than 24,000 Hz, e.g., 0.1-10 MHz, a negative voltage of 30-100 kilovolts (kV), and a current of 0.1-150 mA.

Example embodiments of an apparatus and a system used to filter, clean and purify gaseous media while converting components extracted from the media to elemental components is now described with reference to the figures.

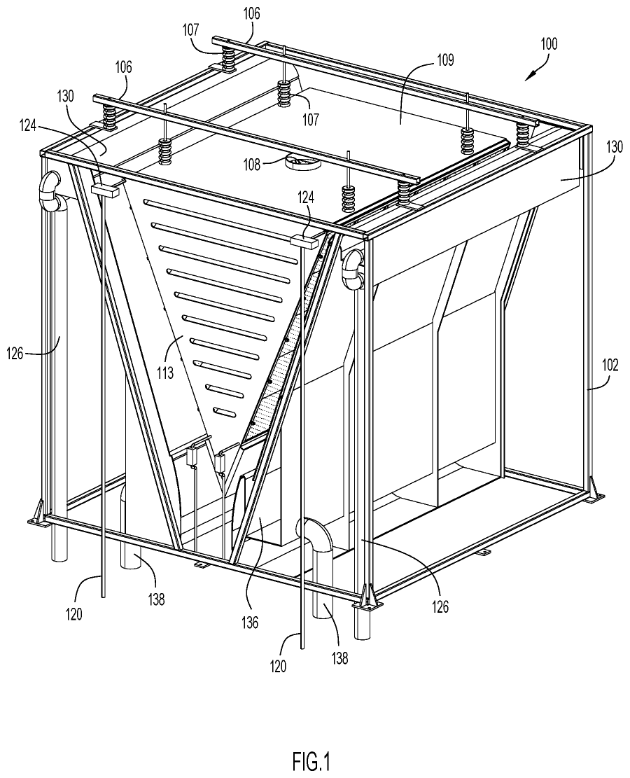

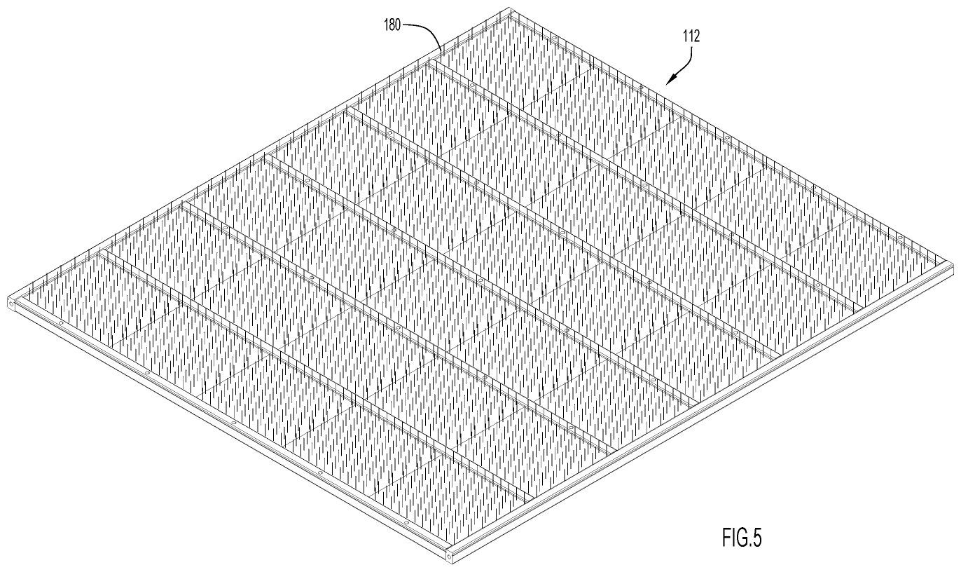

Referring to FIGS. 1-5, a single apparatus 100 is depicted that includes a housing and structure configured to receive a gaseous media (e.g., exhaust effluent from an industrial plant), convert oxide compounds into elemental materials and collect such elemental materials in a water stream. The apparatus 100 includes a frame 102 and cross beams 106 that support components of the apparatus, including electrode beds 112 and air inlet panels and louvre walls 113. A high voltage isolator support device includes insulators 107 that extend from and are thus also supported by the cross beams 106. The cross beams 106 and voltage isolator support device support the top panel 109, electrode beds 112 and louvre walls 113. A pair of outer walls 114 are provided on each side that includes a louvre wall 113, where each outer wall 114 is spaced a slight distance for the corresponding louvre wall 113 to permit airflow between the two walls (so that air can enter the slits in the louvre walls 113 during operation). Each electrode bed 112 includes a plurality of electrodes 180 arranged in a manner as depicted in FIG. 5 and further described herein. An air vent 108 is provided in communication with the top panel 109 to facilitate gaseous and/or air flow from the apparatus.

Conduits or pipes 120 provide cleaning medium to the needle electrodes of the electrode beds via valves 122 and through nozzles 124 directed at and along various locations of each electrode bed 112 so as to clean the needle electrodes at selected times of operation. The apparatus 100 includes a pair of electrode beds 112, each bed comprising a panel having a generally rectangular and planar configuration and aligned within the apparatus at opposing sides of the housing 102 and angled toward each other in a manner as described herein. Each electrode bed 112 includes a plurality of electrodes 180 extending transversely outward from a planar reaction surface of the bed 112 and toward a corresponding water overflow panel 132 that is aligned generally parallel with the bed 112. In this configuration, the electrode beds 112 are aligned in relation to each other such that the planar reaction surface of each bed 112 (from which the electrodes 180 extend) opposes or faces away from the planar reaction surface of the other bed 112. The electrodes 180 of each electrode bed 112 extend toward but are spaced a suitable distance from the corresponding water overflow panel 132 that is aligned with the bed 112. While the reaction surfaces of the electrode beds depicted in the drawings are generally flat or planar in configuration, it is noted that the apparatus can be modified to include any suitable reaction surface for one or more electrode beds that can be planar, curved or combinations of planar and curved. In another example embodiment, an electrode bed can comprise a rounded of funnel shaped configuration in which electrodes extend from one or more rounded reaction surface portions of the electrode bed.

Water supply conduits or pipes 126 provide inlet water (e.g., water from a flotation tank 212 when the apparatus is implemented in a system as described herein) to the reaction zones within the apparatus 100 during operation. In particular, located on each side of the housing 102 that corresponds with the locations of the electrode beds 112 is a pair of water supply structures 128. Each water supply structure 128 includes an upper water pocket 130 (e.g., a reservoir or trough), a water overflow panel 132, and a lower water collection pocket 136 (e.g., a reservoir or trough). Each upper water pocket 130 is connected with an outlet end of a corresponding water pipe 126 located at or near the top of the housing 102. As water from the pipe 126 fills the upper water pocket 130, the upper water pocket 130 eventually overflows to provide water across and down along a reaction surface of a corresponding water overflow panel 132. Each water overflow panel 132 is generally parallel in orientation in relation to its corresponding electrode bed 112 and is thus angled inward as it extends from the upper or top side to the lower or bottom side of the housing 102 for the apparatus 100. Similar to the reaction surfaces of the electrode beds, each water overflow panel is depicted in the drawings as having a reaction surface (i.e., surface upon which water flows) that is generally flat or planar. However, the apparatus can be readily modified to include one or more water overflow panels with reaction surfaces having a curved configuration or combinations of planar and curved configurations.

In operation, water flows at the top of the apparatus from pipe 126 to the upper water pocket 130, fills the pocket 130 and then overflows from the pocket 130 down and along the water overflow panel 132. A corresponding lower water pocket 136 is located at a bottom edge of each electrode bed 112 and corresponding bottom edge of the corresponding water overflow panel 132 so as to catch and retain the water as it drains from the overflow panel 132. This allows water to flow evenly, during operation, across the water overflow panel 132 and proximate needle electrodes 180 that are connected with each electrode bed 112 and extend toward (but are separated from) the corresponding plane 13.

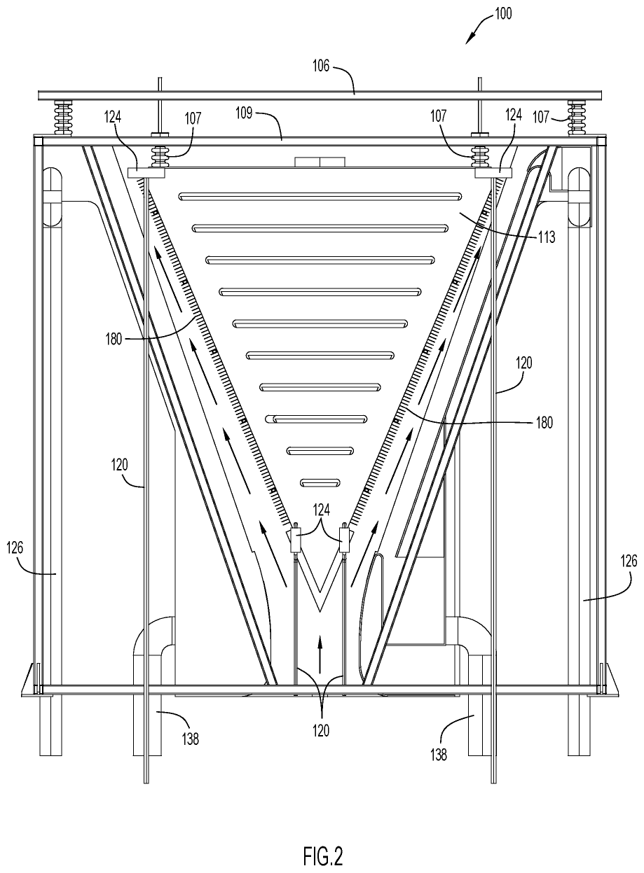

As shown, e.g., in FIGS. 2-4, the reaction surface of each electrode bed 112 (including electrodes 180) faces toward the reaction surface of the corresponding water overflow panel 132 (the surface over which water flows), where the two reaction surfaces are spaced from each other a suitable distance to permit gaseous fluid (e.g., air entrained with oxide compounds such as carbon oxides, sulfur oxides, etc.) flowing within the housing 102 to extend between a water layer flowing along the reaction surface of the water overflow panel 132 and the reaction surface including electrodes 180 of the corresponding electrode bed 112. The water flows from the top to the bottom of each water overflow panel 132, and thus from the top to the bottom of the apparatus. Water return conduits or pipes 138 are connected with the lower water pockets 136 so as to collect and deliver water exiting from the lower water pockets to a suitable collection tank or collection site (e.g., the flotation tank 212 of system 200, described in greater detail herein).

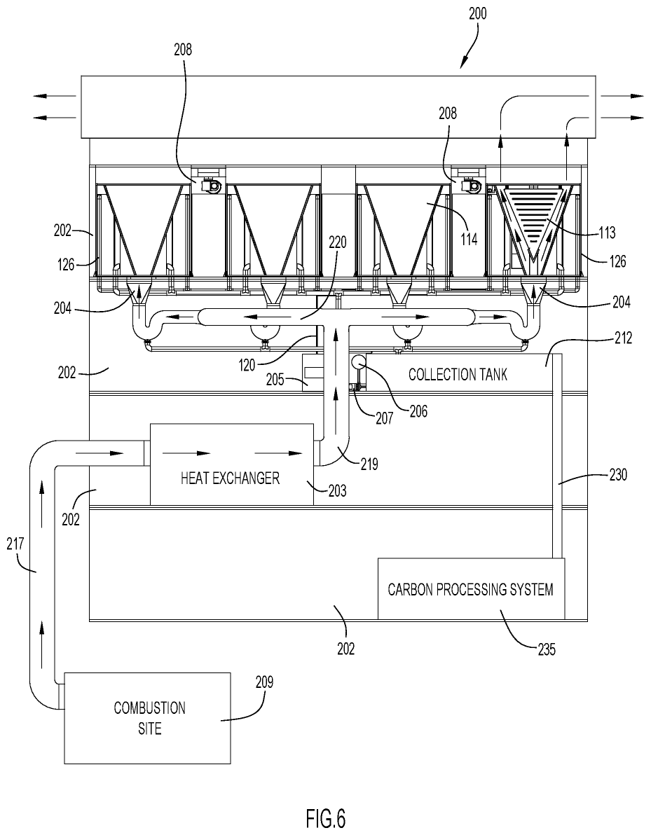

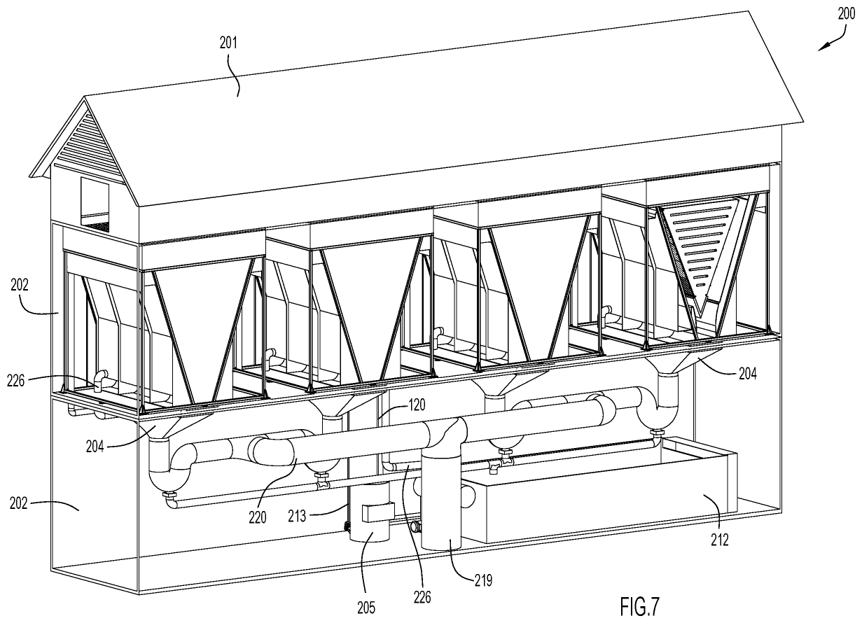

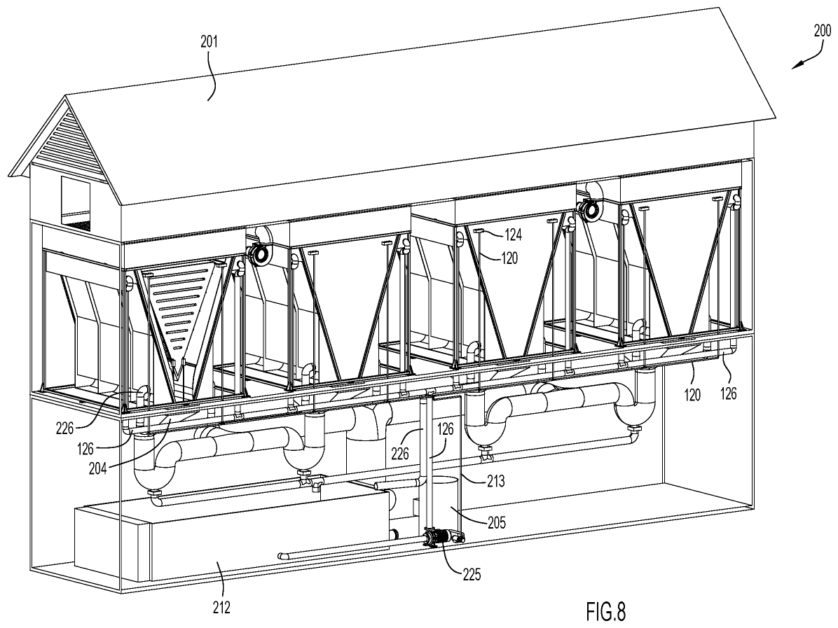

Flow of gaseous fluid to be processed by the apparatus 100 enters the housing 102 via an inlet at the lower or bottom end of the housing. For example, the gaseous fluid inlet to the housing 102 can be via a lower hood or register (e.g., register 204 as shown in the system 200 of FIGS. 6-8) located at the bottom of the apparatus 100. The gaseous fluid flows through the housing 102, into a reaction zone within the housing which includes the electrode beds 112 and the water overflow panels 132 (including water flowing along such planes 132) and exits at or near the top of each apparatus (e.g., through the panel 109 via air vent 108). Thus, the gaseous fluid flows countercurrent to the water flow within the apparatus during operation.

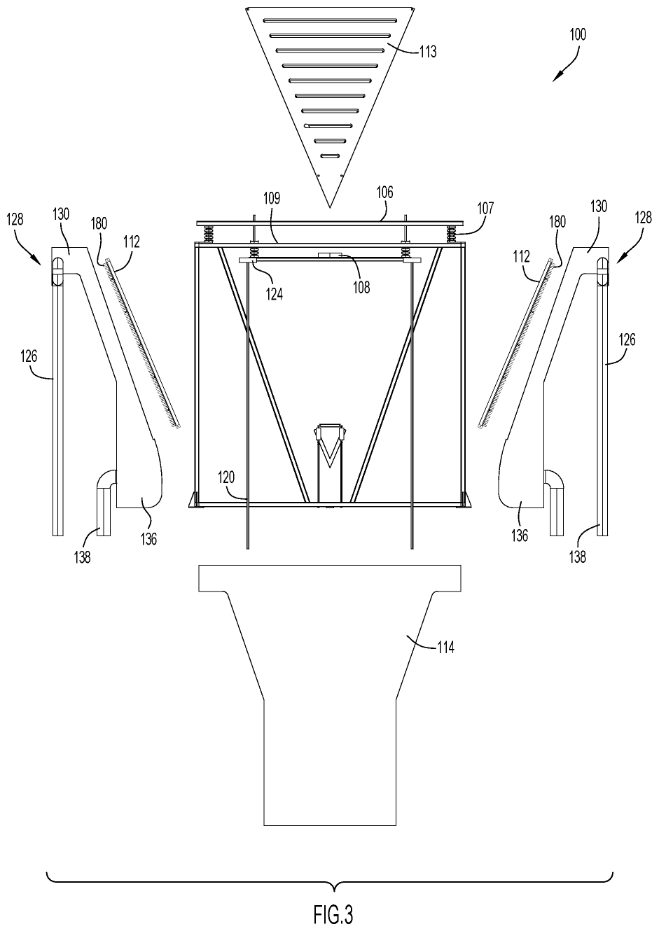

Referring to FIGS. 3-5, each electrode bed 112 includes a plurality of electrodes 180 provided in one or more suitable arrays along the reaction surface of the bed 112. As shown in the example embodiment, the apparatus 100 includes two electrode beds 112 formed as planes that are spaced from each other and are aligned non-parallel in relation to each other so as to angle toward each other (i.e., each bed is at an angle and thus not perpendicular to the top and bottom sides of the apparatus), where a spacing between the beds decreases from the top to the bottom of the apparatus. In an alternative embodiment, fluid flow and apparatus can be configured such that the spacing between the beds can increase from top to bottom of the apparatus.

The electrodes 180 of each bed 112 comprise electrically interconnected needles that are connected to a high-voltage power source via an injector (not shown) such that the power source provides electrical energy to the electrode needles during operation. The injector is connected with the high voltage insulator support device including insulators 107. The electrode needles are spaced apart from each other and are installed on each electrode bed 12 in a suitable arrangement (e.g., a staggered order as depicted in FIG. 5), and the injector is made of a dielectric material and is a three-dimensional hollow body. The needles can be formed of stainless steel or any other suitably conductive metal or other material. The needles forming electrodes 180 can have any suitable dimensions. In an example embodiment, the needles can have a length from about 30 mm to about 50 mm (e.g., a length of about 40 mm) and a diameter (or transverse cross-section) ranging from about 0.5 mm to about 1.2 mm (e.g., a diameter of about 0.8 mm). In addition, rows of needles can be defined within the array of electrodes (e.g., where a row is defined by any set of electrodes extending along an imaginary line within the array), where the spacing between electrode needles is set to enhance performance of the electrode beds during operation of the apparatus. In preferred embodiments, spacing between any two consecutive electrode needles in a row can range from about 15 mm to about 30 mm, more preferably from about 18 mm to about 25 mm (e.g., about 22 mm). In addition, electrode needles in one row of the array are staggered (i.e. not aligned) in relation to electrode needles in another consecutive row.

The array of needle shaped electrodes 180 can be provided and/or formed with each electrode bed 112 in any suitable manner. In an example embodiment, each needle forming an electrode 180 can be inserted through a #16 Gauge insulated, stranded conductor wire, where the needle breaks the outer insulation of the wire and is in intimate contact with the conductive strands within the wire. Each wire can be connected with the high voltage power source to deliver electrical current to each needle during operation. The planar structure of each electrode bed 112 can be constructed of a suitably rigid and insulative material, such as ABS (Acrylonitrile Butadiene Styrene) plastic or other suitably insulative polymer material. The planar structure for each electrode bed can be fabricated with holes drilled in any suitable pattern or array to receive the needles as they emerge from the opposite end of the wires. Through intimate contact with the wire, each needle is part of a larger array that is coupled directly to the high voltage power supply via the wires, thus forming a geometrically spaced combined needle electrode. This electrode supports the formation of an electric field within the reaction zone 190 between the electrode beds 112 and the reaction surfaces of corresponding water overflow panels 132.

The needles can be coupled with the planar structures of the electrode beds manually (e.g., individually by hand) or, preferably, via any suitable automated process (e.g., utilizing conventional factory assembly methods). In an alternative embodiment, techniques can also be used to form the electrode beds that are similar to methods for forming wiring or printed circuit boards. For example, a copper clad fiberglass substrate material can be used that has very high fire rated resistance. Further, due to the high electrical resistance of fiberglass, it also has a high dielectric constant so as to support an electric field without breaking down and becoming an electric current conductor in the presence of a high voltage. The copper clad fiberglass substrate board can be fabricated by bonding a thin continuous layer of copper over a large sheet of fiberglass. Utilizing chemical etching, the wiring pattern is formed by removal of the copper that is not part of the wiring pattern itself. Drilled holes through the planar structures can receive the needles, where the holes are provided such that the needles are in contact with wiring in the planar structures to complete the electrical connection with the high voltage power source (based upon electrical coupling of the wiring with the power source).

In another example embodiment, the electrode needles are provided in rows and connected in series along a continuous solid conductor, where each needle is crimped to the serial conductor. This is only requires a single crimp for each electrode in which each needle connects with the solid conductor, which significantly enhances performance of the electrode bed and prevents electrical arcing from occurring during operation of the electrode bed in the apparatus.

The needles for each electrode bed 112 can also include a coating that can reduce electrical resistivity and provide excellent adhesion to the substrate, exhibit good wear properties and be able to withstand temperatures between −30° C. to 1400° C. In certain applications, some metals used in the coating can further enhance ionization and/or plaron reactions to dissociate oxide compounds into elemental (and/or allotropic) materials by acting as catalysts to the reactions. Coatings can be formed on the needles as follows. A bath is formulated with poly metallic alloys, produced by electroless nickel techniques. The baths can contain a nickel cation source and may be reduced utilizing boron or phosphorus. Complexing and reducing agents can be added to control the rate of plating. Additional metal cations sources can be added, producing a co-deposited alloy.

The material deposited on the needles forming the electrodes 180 can comprise any one or more of nickel, tungsten, boron, copper and carbon (e.g., carbon nanoparticles and/or coarse carbon particles). In example embodiments, the deposited material can comprise two or more of nickel, tungsten, boron, copper and carbon (e.g., carbon nanoparticles and/or coarse carbon particles). In a specific example embodiment, the deposit material can comprise primarily or substantially (i.e., greater than 50% by weight of the deposit material) nickel, and can further comprise tungsten in an amount from 3% to 6% by weight of the deposit material, boron in an amount from 1% to 3% by weight of the deposit material, copper in an amount from 0.5% to 1% by weight of the deposit material, and carbon in an amount of 1% to 3.5% by weight of the deposit material. For example, carbon can be present in an amount of carbon nanoparticles (e.g., particles less than 1 micron in size) in an amount from 0.05% to 0.20% by weight of the deposit material, and coarse particles of carbon (e.g., particles at least 1 micron in size) in an amount from 1% to 3% by weight of the deposit material. Electroless Nickel plating solutions can be used to form deposits comprising one or more of the material components as described herein. Adjustments to the plating bath can be made, dependent on the requirement of the coating for the end product use. The conditions to operate the electroless nickel bath are dependent on the final thickness of plating, morphology of coating and incorporation of alloying materials.

The high voltage source providing electrical energy to the electrodes 180 of the electrode beds 112 can comprise a high voltage (HV) discharge arrester that controls arcing and flashover from corona discharge associated with a high voltage source of Electro Motive Force (EMF), which is the case with the light plasma conditions present near the reaction zone of the oxide compounds dissociation and elemental material capture process. The HV discharge arrester can be comprised of a plurality of 33,000 Ohm, 5 Watt resistors with a ceramic body, immersed in automotive power transmission fluid oil and placed in a plastic container also providing high isolation to prevent external arcing. The oil fulfills a function similar to transformer oil which is to provide insulation by increasing the dielectric constant, isolation, suppression of arcing and corona discharge, and cooling. In general, a resistor is a component that opposes current flow in a circuit, and thereby dissipates heat as a result of electrical current flowing through it. To create 1 Million Ohms (megohm) of total resistance for the HV discharge arrester, e.g., 31 resistors configured in series can be provided, with each resistor having 33,000 Ohms of resistance, with a power handling capacity of 155 continuous Watts of dissipated power. This configuration is particularly effective utilizing an electrode array for an electrode bed in which only a single crimp for each electrode is required (i.e., crimping each needle to a serial conductor), since this configuration effectively eliminates the chance for electrical arcing during operation. Other configurations are possible to increase the overall resistance of the array. The HV arrester uses a plurality of resistors arranged in a series configuration whereby individual resistors are attached end to end physically and thus electrically, which increases the total resistance in proportion to the number of resistors. Another property of a resistor that is relevant to this arrestor is the power handling. Every resistor is rated according to the safe power dissipation range that it can operate at. The rating of 5 Watts for each resistor is a measure of how much power can be handled by that resistor without causing stress to the ceramic body or the bonding of the connection wires to the body. Power dissipation in an electronic component manifests as radiated heat, thus each 5 Watt resistor in series increases the power handling capability by 5 Watts, as it increases the surface area available to support the heat dissipation. The transmission oil additionally provides a means to cool the resistive array when in operation.

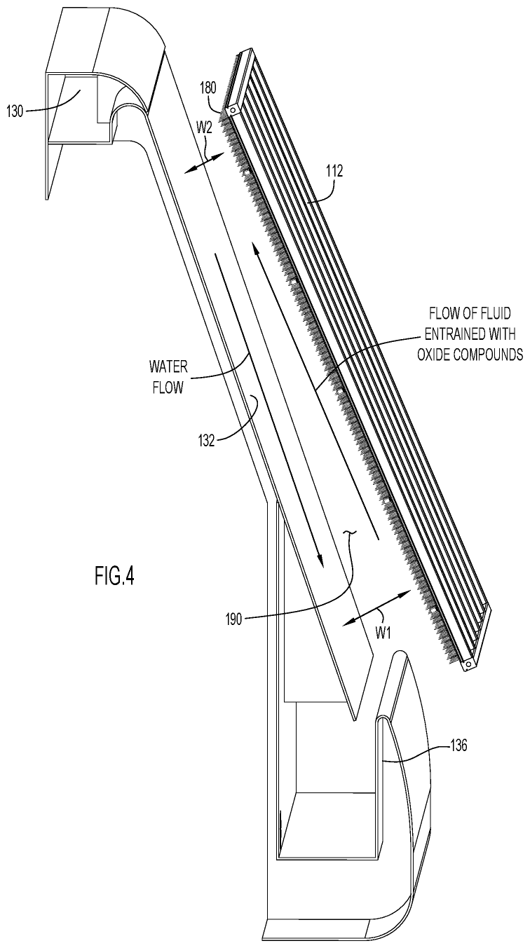

The reaction zone 190 is defined between reaction surfaces of each water overflow panel 132 and electrode needles (i.e., electrodes 180) protruding from the corresponding electrode bed 112 that is distanced from and in near parallel alignment (but slightly offset from parallel alignment as shown in FIG. 4 and as described in further detail herein) with the plane 132 along opposing sides of the apparatus 100. The water flow via pipes 126 is controlled during operation to ensure formation of a continuous thin water film along the reaction surface of each water overflow panel 132 as the water flows down each plane 132 to the lower collection pocket 136. This continuous thin water film along the reaction surface of each water overflow panel 132 functions as a liquid electrode in the reaction zone 190. The electrodes 180 of each electrode bed 112 for each reaction zone 190, which face toward and are spaced from the reaction surface and the thin water film of the corresponding water overflow panel 132, also function as a combined electrode for the high voltage injection of the apparatus.

A distance or spacing between the tips of the needle electrodes 180 and the reaction surfaces of the corresponding water overflow panels 132 can be set and/or adjusted via any suitable suspension mechanism associated with the water supply structure 128 and/or suspension mechanism implemented in the support beams 106 and/or high voltage isolator support device that is supported by the support beams. In a non-limiting example embodiment, this spacing (i.e., reaction zone width) can be from about 140 mm to about 150 mm.

Each water overflow panel 132 and its corresponding electrode bed 112 are aligned in relation to each other in a near parallel manner, but not precisely parallel, such that the reaction zone width varies along a fluid flow direction through the reaction zone, or along a length of the reaction zone. In particular, each water overflow panel 132 can extend from the top panel 109 (or a plane parallel to the top panel 109) and in a direction away from a central lengthwise axis of the housing 102 at a first included angle from about 690 to about 730 (e.g., about 710). Each electrode bed 112 can extend from the top panel 109 (or a plane parallel to the top panel 109) and in a direction away from the central lengthwise axis of the housing 102 at a second included angle from about 650 to about 700 (e.g., about 67°). The first included angle for each water overflow panel 132 differs from (e.g., is greater than) the second included angle for each electrode bed 112. This results in the gap or distance between the tips of the electrodes 180 and the reaction surface of each corresponding plane 132, defined as the reaction zone width, that varies and decreases in a direction from the lower end or bottom of the housing 102 (width W1 as shown in FIG. 4) to the upper end or top panel 109 of the housing 109 (width W2 as shown in FIG. 4). To put in another manner, the reaction zone width decreases in a direction of flow of fluid entrained with oxide compounds through the reaction zone 190 (i.e., the reaction zone width decreases in a direction from the reaction zone inlet or bottom of the housing 102 to the reaction zone outlet or top of the housing 102 at or near top panel 109). In other embodiments, the gap or distance (reaction zone width) can increase in a direction of fluid flow of fluid entrained with oxide compounds through the reaction zone. It is believed that varying the gap or distance (or reaction zone width) along the reaction zone 190 in the manner described herein enhances the ionization and/or plaron reactions within the reaction zone as the gas (or other fluid) to be processed traverses the reaction zone from inlet to outlet of the apparatus 100 and the oxide compounds/particulates removed from the gas and converted to elemental material.

In response to the application of a suitably high voltage at a suitable frequency (via the high voltage power source) and current to the electrodes 180, ionization and/or plaron reactions of compounds entrained within the gaseous fluid provided to the apparatus 100 (via hood or register) are facilitated within the reaction zone 190 (defined between the ends of the electrode needles and the liquid electrode defined at the reaction surface of the water overflow panel). This results in dissociation of the entrained compounds and generation of elemental materials or components (e.g., elemental carbon, elemental sulfur, etc.) that are removed from the gaseous fluid and are further captured and entrained in the flowing water that defines the continuous thin water film along the reaction surface of each water overflow panel 132. The water exiting the lower water collection pockets 136 can be collected (e.g., in the system 200 described herein), where elemental components can then be separated from the collected water for further processing and/or further use in other applications.

Operation of the apparatus is achieved by providing a gaseous fluid including entrained compounds to be removed from the gaseous fluid. For example, the gaseous fluid can comprise an exhaust air stream from a combustion process, where the exhaust air stream is entrained with oxide compounds such as carbon oxides, sulfur oxides, lead oxides, zinc oxides, iron oxides, magnesium oxide and silver oxides. As noted herein, the apparatus is also operable to process a fluid such as a liquid (e.g., water) or a combination of water and gas. A high voltage source (e.g., a transformer high voltage generator) is electrically coupled with the electrodes 180 of the electrode beds 112 so as to apply a voltage in a range of 30 kV-100 kV (e.g., from 30 kV-80 kV) at a high frequency (e.g., greater than 24,000 Hz, preferably 0.1-10 MHz) and a current of 0.1-150 mA at the reaction zone 190 of the apparatus 100.

A continuous film of water is provided along the surface of each overflow panel 132 (e.g., via water circulating pump delivering water to pipes 126, to upper water pockets 130, and then downward along each overflow panel 132). The exhaust air (or other fluid) stream flow containing oxidized particulates is introduced into the apparatus 100 at the bottom of the housing 102 (e.g., via register) so as to flow through the reaction zones 190. The apparatus 100 can be used to treat gaseous fluids at any desired temperature. In an example embodiment, the apparatus 100 can be used to directly treat a fluid flow at a temperature ranging from about 10° C. to about 200° C. or greater (e.g., from about 30° C. to about 90° C.). Temperature management of the fluid flow can be achieved via a heat exchanger and/or via direct air capture from the surrounding environment. For example, louvre walls 113 that oppose the electrode beds 112 include openings or slits that permit air to flow into the housing 102 from the ambient surroundings and then exit from the air vent 108 at the top panel 109, and this makeup air can be used to control temperatures at the reaction zones 190. The slits in the louvre walls 113 can be selectively adjusted to control an amount of air that can flow into the housing at any given time during operation.

The exhaust air flow entering the housing 102 from below (e.g., via register) fills the reaction zones 190 of the apparatus 100. In particular, the exhaust air flow enters at the lower or bottom end of the housing 102, travels upward and into the reaction zones 190 in the housing 102, then through the reactions zones 190 and exiting the apparatus 100 at the air vent 108 of the top panel 109. An air curtain can be formed within the housing 102 by providing an air curtain structure that delivers forced air (via a fan or blower, not shown) downward into the spaces between outer walls 114 and louvre walls 113, where the forced air further flows through the slits of the louvre walls 113 and continues downward to provide an air current at a central location near the bottom of the housing 102 in which the exhaust air flow enters. This forces the exhaust air to flow toward opposing sides of the apparatus housing and into and through the reaction zones 190 (as shown by the arrows in FIG. 2 and in the system 200 depicted in FIG. 6).

In the reaction zones 190, the entrained oxide compounds within the exhaust air dissociate via ionization and/or plaron reactions to form elemental compounds (e.g., allotropes of such elemental compounds) as a result of the high voltage applied between the electrodes 180 and the thin water film layer (water film layer electrode) disposed along each water overflow panel 132. The velocity of the exhaust air entering the reaction zones can be controlled (e.g., accelerated or decelerated) to enhance the interaction between the point source electrodes 180 (needle tips) and the oxide compounds thus controlling the conversion of oxide compounds to elemental components (e.g., elemental carbon, elemental sulfur, elemental lead, elemental zinc, elemental magnesium, elemental silver, etc.). The elemental components formed from the dissociation of oxide compounds within the exhaust air stream are further separated from the air stream and are absorbed into the thin water film defined by the water flowing along each water overflow panel 132. The elemental material may be separated, discarded, processed, etc., as desired. Certain elemental components (e.g., elemental carbon in the form of graphite, graphene, fullerenes and/or nanotubes) can be utilized for other processes. The fluid free of oxidized compounds exits the apparatus via one or more outlets at the top panel 109 of the housing 102.

Thus, the apparatus 100 facilitates gas or other fluid to be processed within the reaction zones 190 of the apparatus in a flow from bottom to top of the apparatus, while water that forms an electrode and collects elemental material formed in the reaction zones 190 flows (e.g., via gravity) from top to bottom of the apparatus or in countercurrent flow to the process gas or fluid containing the oxide compounds. Alternatively, fluid to be processed and water flow can be in opposite directions to those set forth in the embodiments depicted in the drawings, while still maintaining countercurrent flow between fluid to be processed and water flow.

The apparatus can have any suitable dimensions for a particular application and based upon a volume of fluid that is to be processed in a given time period.

In other embodiments, a plurality of apparatuses can be coupled together in parallel or in series with regard to fluid flow through the apparatuses. For example, apparatuses can be connected together in series in which fluid entrained with oxide compounds flow from an outlet of one apparatus to an inlet of a consecutively aligned apparatus, etc. for any number of apparatuses linked in series. Alternatively, each apparatus can arranged in parallel flow with regard to the flow of fluid entrained with oxide compounds, where each apparatus separately and independently processes a portion of the fluid. Similarly, the apparatuses can be aligned in series flow or parallel flow with regard to the water flow (which entrains elemental materials formed from the apparatuses) to each apparatus.

Systems can be configured to house or contain a single apparatus or a plurality of apparatuses (arranged in series and/or parallel with regard to flow of fluid entrained with oxide compounds and/or water flow). In certain applications, providing apparatuses in series for the fluid to be processed can achieve greater efficiencies with regard to oxide compound removal and conversion to elemental materials. In certain other applications, and depending upon the volumetric flows required to be processed over a certain time period, systems may provide apparatuses in parallel with regard to flow of fluid to be processed so as to ensure sufficient processing of large amounts of fluid at a given time.

An example embodiment of a system 200 including a plurality of apparatuses 100 is depicted with reference to FIGS. 6-8. The system 200 includes a housing with a structural roof assembly 201 and a plurality of vertically stacked units, containers or compartments 202. The size of the compartments 202 can vary based upon the size requirements for the apparatuses 100 and/or other system components. In an example embodiment, one or more (e.g., all) of the compartments 202 can be as large as about 12 meters in height (e.g., 40 foot high). The system 200 is described with regard to processing of a gaseous stream obtained from a combustion site 209. However, the system can be used with any other types of industrial systems and for a wide variety of different types of gaseous streams (or liquid streams, or combinations of gaseous and liquid streams) to be purified including atmospheric air or Direct Air Capture (DAC) (in which atmospheric air can be treated and purified from oxides including, without limitation, carbon oxides, sulfur oxides, and other oxide compounds).

A gaseous stream or combustion gas product obtained from combustion site 209 is delivered via a process flow path 217 (e.g., via suitable conduits or supply piping) to a heat exchanger 203 located within one of the compartments 202. The heat exchanger 203 can be used to cool the gas product exiting the combustion site 209, where energy captured from the heat transfer between the gas product and a coolant fluid of the heat exchanger 203 can be utilized in another process. The gas stream emerging from the heat exchanger 203 is then directed to another compartment 202 located above the compartment 202 which houses the heat exchanger 203. The compartment(s) 202 above the heat exchanger compartment 202 houses a plurality of apparatuses 100. While four apparatuses 100 are depicted in the system 200 of FIG. 2, it is noted that the system can be scaled in any manner to include any suitable number (e.g., one, two, three or more) apparatuses 100 for use in cleaning/purifying the gaseous stream and removal and conversion/capture of elemental components or materials in the water streams flowing through the apparatuses. Apparatuses can also be aligned in any suitable manner within the container of the system, including any number of rows and/or columns of apparatus within the container. As previously noted, the apparatuses 100 are arranged in parallel with regard to both flow of combustion gas and water within the apparatuses.

The gas stream flows through a conduit 219 from an outlet of the heat exchanger 203 and then into a manifold 220. The manifold 220 delivers gas into each apparatus 100 at an inlet 204 (also referred to as a register) located at a lower or bottom end of each apparatus. As shown in a partial cut-out view of one of the apparatus 100 of FIG. 6 and further as shown in FIG. 2, the gas flows upward through each apparatus within the reaction zones 190 provided within the apparatus (as indicated by the arrows within the reaction zones 190), where the gas is in close proximity and/or contact with electrodes 180 disposed on the electrode beds 112 which extend outward and into each reaction zone 190. Processed and cleaned/purified air emerges from each apparatus at a top location of each apparatus 100 (e.g., from the air vent 108 at the top panel 109 of the housing 102 for each apparatus). The purified air is delivered via a suitable purified fluid delivery structure (e.g., one or more conduits within the structural roof assembly 201) out of the system 200 and into the surrounding or ambient environment.

One or more air curtain blowers 208 are suitably aligned with each apparatus 100 so as to blow air into the apparatuses between each louvre wall 113 and corresponding outer wall 114, where the air is blown downward within the housing 102 for each apparatus 100 to create an air curtain which forces the combustion gas stream to split from the inlet 204 and be directed through each reaction zone 190 (as shown by the arrows in the partial cross-sectional view of the apparatus 100 for FIG. 6).

A water recirculating system for the system 200 includes a water pump 225, piping 126 providing water to the apparatuses 100 (via upper water pockets 130), and outlet or return piping 226 that returns water emerging from the apparatuses (from lower water collection pockets 136) to a collection tank 212. The operation of each apparatus has been previously described herein. Water entrained with elemental material flows from each apparatus 100 (via return piping 226) to the collection tank 212, where the collection tank 212 can be configured to filter and/or separate and collect solid elemental materials from the water for further processing. The filtered water, substantially free from elemental materials and other solids, can then be recirculated via the water pump to piping 126 and back to the water inlets of the apparatuses 100.

Elemental components or materials (e.g., elemental carbon materials such as fullerenes and/or carbon nanotubes, elemental sulfur materials, etc.) filtered and/or separated from the collection tank 212 can be delivered, e.g., via a chute 230, to a processing system 235. The processing system 235 can process the elemental materials in any suitable manner including, without limitation, modifying the materials in any manner and depending upon a particular application. The collection tank 212 can further comprise a dissolved air flotation (DAF) tank that includes an air bubbler pump 207 and a pressurizer 206 connected with the tank 212 to provide air bubbles within the water in the tank which can enhance separation of elemental and/or other solid materials (e.g., compounds comprising carbon, sulfur, iron, etc.) from the water.

The system 200 further includes a cleaning solution to selectively clean electrodes within each apparatus 100, where an electrode cleaning solution pump is provided to direct cleaning fluid from a cleaning fluid reservoir 205 and into each apparatus 100 via cleaning liquid pipes 120 and valves 124 (shown, e.g., in FIGS. 1 and 6), where the cleaning solution is pumped into and then returned to the reservoir 205 via return pipes 213 and the pump.

The system 200 provides enhanced purification of gases from harmful impurities and particulates, including oxide compounds as noted herein.

Operation of the system 200 is described as follows. A polluted gaseous stream (e.g., flue gas) is injected into a chimney located under or adjacent a gas cleaning plant or other combustion site 209 including the system 200. Under the action of assisted thrust, the gaseous stream passes at low or little pressure between the tips of the electrodes 180 of the electrode beds 180 for each apparatus 100. The air curtain delivered via the air curtain blower 208 is used to create air walls through the slots of the louvre walls 113 to force gaseous emissions into and through the reaction zones 190 of the apparatuses 100, after which treated emissions are released from the apparatuses and the system 200 into the atmosphere. The water electrode for each apparatus 100 is formed by water flowing down each water overflow panel 132 from the upper water pockets 130, and serves as an acceptor of the extracted impurities. Water with precipitated impurities (elemental materials and/or other solid materials) is collected in the lower water pockets 136, then drained by gravity via piping 226 to the DAF tank 212. The water is processed and filtered to remove the solid materials. Once filtered, water is pumped back to the upper water pockets 130 (via pipes 126) for reuse by each apparatus 100. A voltage from 30 kV to 100 kV (e.g., from 30 kV to 80 kV) is applied to the electrodes 180 of the injector from a high-voltage source (e.g., of the type previously noted herein) and at a pulse frequency greater than 24,000 Hz, preferably ranging from 0.1-10 MHz, and at a current ranging from 0.1 to 150 mA.

Thus, the apparatus, system and methods described herein provides for enhanced removal and conversion of oxide compounds from gaseous streams containing contaminants into elemental materials. Gaseous streams can be purified and the elemental materials formed from the process utilizing the apparatus and/or system (including a plurality of apparatuses) can be of significant value for different applications.

The use of two separate reaction zones in each apparatus (each reaction zone provided between the water overflow panel and corresponding electrode bed) provides enhances processing of the fluid (purification and formation of elemental materials). In addition, the change in width of the reaction zone along the flow path defined between each electrode bed and corresponding water overflow panel (where the reaction zone width decreases in a direction from the reaction zone inlet or bottom of the housing to the reaction zone outlet or top of the housing) can enhance the ionization and/or plaron reactions of oxide compounds within the fluid as it flows along each reaction zone.

In alternative embodiments, a liquid stream (e.g., water) can be purified by passing the liquid stream through the reaction zones of an apparatus or system including a plurality of apparatuses as described herein and in the same or similar manner as noted herein for a gaseous stream to facilitate removal of components comprising particulates and oxides as well as conversion of oxides within the liquid stream into elemental substances and/or allotropic substances prior to their removal from the liquid stream. Further still, a combined gas and liquid stream can also be process by the apparatus and system utilizing the same techniques as described herein.

The system, apparatus and methods described herein also facilitate cleaning of air or other gaseous and/or liquid input streams from all oxides, particulate, dust, mold, Fungus spores and bacteria with high efficiency. Air flow or emission flow enters the bottom areas of the apparatus. In an example embodiment of the system (e.g., as shown in FIGS. 6-8), the reaction zones are provided in four open channels (e.g., four apparatuses in parallel), which are further divided into eight subchannels (two reaction zones per apparatus) which flow upward and are treated with ionization and/or plaron reactions causing oxides to recombine into solid elemental materials including allotropes of such elemental materials (e.g., carbon allotropes such as graphene, graphite, fullerenes and carbon nanotubes, and sulfur allotropes). Oxygen and nitrogen can be released in the form of inert gases due to the dissociation reactions in the reaction zones, and these inert gases travel with the processed air exiting the apparatuses and system and into the atmosphere.

As a result of the process occurring in the near-electrode, fouling, high-voltage discharges are generated and electrons are released, which collide with the molecules of polluting components, exciting them and destroying the structure of these components. The process of electrochemical and/or electrophysical transformation of oxides to solid chemical elements results. Interphase exothermic and endothermic reaction occurs at each zone above the needle tip, which significantly intensifies the conversion process.

As previously noted, the high voltage processing conditions (e.g., voltage of 30-100 kV pulsing at a frequency of greater than 24,000 Hz, preferably ranging from 0.1-10 MHz, and applied current from 0.1-150 mA) can be applied to the electrodes of the electrode beds, resulting in conversion efficiencies for carbon oxide, sulfur oxide, nitrogen oxides, etc. of up to 99.95%.

Utilizing high-voltage discharges within the reaction zones of the apparatus and/or system can provide high-quality air purification in relation to disinfection and/or sanitization of the air from various viruses and bacteria due to resonant exposure, in which periodic external exposure causes a sharp increase in the amplitude of stationary vibrations of microorganisms. When the frequency of external influence coincides with the frequency characteristic of microorganisms, its destruction occurs. At the same time, in the claimed voltage and current range, conditions will be created for the occurrence of a resonance that has a detrimental effect on viruses and microorganisms. There is a 90% or more dissociation of the air from oxides, dust, aerosols, bacteria and viruses. Additionally, VOCs, Furans, and Dioxins are also dissociated in the process. Due to the resonance, an additional effect on the chemical bonds of polluting components is provided, leading to the destruction of these bonds and the neutralization of toxic substances.

Fullerenes are one of the valuable elemental materials that can be recovered using the apparatus, system and method as described herein. Fullerenes are a high value chain and industrially important form of carbon comprising a large closed-cage molecule made up of 60 or more sp²-hybridized carbon atoms, arranged in hexagons and pentagons. Currently, fullerenes are known in the form of spheroids (“buckminsterfullerene”) and cylindrical or toroidal shapes (“nanotubes”). Various complex and expensive processes are known for producing fullerenes. Because the processes are so complex, and the yields so low, the resulting product is extremely expensive. The system, apparatus and methods described herein provide a far more efficient and inexpensive method for producing these materials.

Since the apparatus of the present invention operates on only a small amount of energy, when the apparatus is used to treat the emissions of a coal-operated power plant for example, carbon may be recovered from the plant's smokestack and repeatedly re-used to fuel combustion, greatly enhancing the efficiency of the power plant.

The system, apparatus and methods described herein are also useful in reducing landfill requirements. For example, since the system and apparatus are so efficient in cleaning the air, it makes possible the use of incinerators which have been heretofore banned or discouraged because of the difficulty of effectively controlling the air pollution that they produce. Thus, many materials that otherwise would be incinerated have been land-filled, unnecessarily wasting substantial landfill area. If such materials could be burned in incinerators and treated in the present apparatus, this would greatly reduce the volume of the remaining material (primarily the collected elemental material) which could then be sold as high value materials. Furthermore, already buried landfill material may be mined, incinerated, treated in accordance with the present invention and again could then be sold as high value materials.

In certain embodiments, the air flow containing oxidized molecules and particulates dependent on emission source material can move through a plurality (e.g., three) levels of reaction zones: a first zone just above the tips of the needles for the electrodes of the electrode beds, a second zone located just beyond the first zone, and a third zone located just beyond the second zone and adjacent the flowing water film within each reaction zone. The first zone closest to the needles can be the most reactive, gradually decreasing the further distance away from needle tips.

In embodiments in which a single apparatus is provided, the air or other fluid stream entrained with oxide compounds and/or other contaminants can be recirculated within the single apparatus (e.g., instead of directing the stream from the outlet of the apparatus to the environment surrounding the apparatus). Alternatively, as previously noted, a plurality of apparatuses can be provided in series with regard to flow of a fluid stream to be processed by removal of such oxide compounds and/or other contaminants.

The apparatus, system and methods described herein can be operated indoors or within a contained environment, since the exiting air (or other fluid) flow is essentially free of undesirable particulates. Alternatively, the apparatus, system and methods can be operated in outside environments, preferably with an appropriate rain shield (not shown) protecting the electrode node body, receptor and other potentially vulnerable components of the apparatus.

Elemental carbon materials such as fullerenes can be produced using the apparatus, system and methods described herein. Preferably, when it is desirable to produce a fullerene, a very clean hydrocarbon source (such as jet fuel or paraffin) is burned and treated by apparatus 100 and/or system 200 in order to minimize the presence of impurities in the fullerene final product. The fullerenes produced, including nanotubes, C60, C70, C84 and C120, and newer unknown fullerenes may be segregated (e.g., at processing system 230 of system 200) using conventional techniques.

Further still, other materials formed as a result of the apparatus, system and methods described herein are hydroxy radicals (OH). The hydroxyl radicals that are formed can be used for applications (e.g., clearing methane from the atmosphere).

It is believed that the dissociation of oxide compounds into elemental materials utilizing the apparatus, system and methods described herein may be the result of the production of elemental hydrogen produced at the tips of the point source electrodes within the reaction zones of the apparatus by unipolar ionization and/or plaron reactions, which very actively reduces oxidized gases within the processed stream. However, it is not intended that the apparatus, system and methods described herein should be in any way limited to any theory of operation to produce such elemental materials and purification of processed streams. With this in mind, the following possible mechanisms are suggested for carbon oxide and sulfur oxide reductions as well as formation of hydroxyl radicals in accordance with utilizing the apparatus, system and methods described herein, with other materials such as iron, silver, copper, magnesium etc. being converted to their elemental form by a like mechanism.

a) Complete or Partial Dissociation of Carbon Oxides:

CO₂→C+O₂

CO₂→CO+½O₂

CO→C+½O₂

CO*+CO*↔+C+CO₂CO₂*(Γ)+C(T)→C(O)+CO(Γ)

b) Processes of Recovery Using Atomic Hydrogen:

CO₂+H→C+H₂O

CO+2H→C+H₂O

c) Interaction of Carbon Oxides with Atomic Oxygen:

CO₂*+O→CO+O₂

H₂O=OH−+H+

H++e−=H

4OH−−4e−=O2=2H2O

6H+SO2=H2S+2H2O

SO2+2H2S=3S↓+2H2O

Or

SO2+4H=S↓+2H2O

Similarly, carbon dioxide may be reduced according to the present mechanism:

4H+CO2=C↓+2H2O

CO2+8H═CH4+2H2O

CH4+CO2=2C↓+2H2O

The apparatus, system and methods as described herein provide a number of advantages. Some non-limiting examples of these advantages are described as follows:

A system, apparatus or method that produces carbon allotropes, either fullerenes and their derivatives where their high electron affinity and ability to transfer electrons, can act as acceptors in a solar cell system which is based on electron transport from light excited material (donor) to electrode. The process is mediated by the acceptor molecule. The example of a commonly used acceptor is Phenyl-C61-butyric acid methyl ester (PCMB) which is used with polythiophene (P3HT) as donor.

A system, apparatus or method that produces carbon allotropes either fullerenes and/or their derivatives which are able to hydrogenate and dehydrogenate easily due to their unique molecule structure (consist of carbon atoms only).

A system, apparatus or method that produces carbon allotropes either fullerenes and/or their derivatives, which allow for a commodity scale agricultural amendments to be produced to increase soil carbon.

A system, apparatus or method that produces carbon allotropes either fullerenes and/or their derivatives, represent the future of developing relatively lightweight metals with greater tensile strength, without serious change of the metal ductility, likely because of the small size and high reactivity due to the sp, sp2 and/or sp³ hybridizations of the carbon.

A system, apparatus or method that produces carbon allotropes either fullerenes and/or their derivatives, there is a possibility of their conversion to diamonds with minor rearrangement of the carbon atoms, exerted via pressure.

A system, apparatus or method that produces carbon allotropes either fullerenes and/or their derivatives, to produce superconductivity in the range 19 to 40 K: Especially important are crystalline compounds of C60 with alkali metals and alkaline earth metals. These compounds are the only molecular systems whose superconductivity is at temperatures above 19 K. Observed superconductivity is in the range 19 to 40 K (−254 to −233° C./-425 to −387° F.).

A system, apparatus or method that produces carbon allotropes either fullerenes and/or their derivatives, as a reducing agent for steel production instead of coal or biochar, “Reduction” is a chemical reaction that turns iron ore (Fe2O3) into pig iron (2Fe). Carbon monoxide (CO) is the crucial ingredient (Fe2O3 +3CO→2Fe+3CO2) and is produced in blast furnaces by burning coal. This also produces carbon dioxide as a waste product, which can be used to produce more carbon allotropes with this method.

A system, apparatus or method that produces carbon allotropes either fullerenes and/or their derivatives for use in batteries to decrease electron charging resistance in cathode layer by increasing surface area for electrons to bond to high surface areas significantly reducing electric resistance in these materials.

A system, apparatus or method that produces carbon allotropes either fullerenes and/or their derivatives, as a replacement for metals or to be hybridized with metals in electrical wire due to the materials conductivity, or to create conductive plastics.

A system, apparatus or method that produces carbon allotropes either fullerenes and/or their derivatives, in water purification and sewage treatment.

A system, apparatus or method that produces carbon allotropes either fullerenes and/or their derivatives, lubricants increasing their thermal conductive properties, therefore the ability to accept and move thermal energy either heat or cold more rapidly. Such fullerenes or their derivatives, exhibit significant properties as an additive for lubricity for engine wear and cutting fluids, along with reduction in resistance of wear parts.

A system, apparatus or method that produces carbon allotropes either fullerenes and/or their derivatives, where based on the chemical properties like very high electron affinity and the large number of conjugated double bonds, the material is used as an antioxidants. They are called “radical sponges” due to their ability to interact with a number of free radicals before being consumed.

A system, apparatus or method that produces carbon allotropes either fullerenes and/or their derivatives, to act as these compounds also termed as antiviral agents. One of their most exciting properties is the capability to suppress the human deficiency virus (HIV) replication which led to inhibition of acquired immunodeficiency syndrome (AIDS) manifestation. In more detail, it was observed that fullerene derivatives are able to inhibit HIV protease which in turn prevents HIV 1 replication and the subsequent development of the disorder. Fullerenes possess a great potential for research and development of novel anti-HIV drugs. The antiviral activity is strongly influenced by the relative position of side chains on C60. This can occur by synthesis and subsequent characteristics of series fullerene derivatives which were found to really have antiviral activity, examples are: fullerene pyrrolidines (containing 2 ammonium groups) were described as HIV-1 and HIV-2 antagonists; Cationic, anionic and amino acids derivatives were seen to inhibit hepatitis C virus replication; Amino acid derivatives of C60 were found to be able to inhibit human cytomegalovirus replication; Water insoluble derivatives shown antiviral activity against enveloped viruses.

A system, apparatus or method that produces carbon allotropes either fullerenes and/or their derivatives, are considered to be active for electrochemical oxygen reduction reaction (ORR) for hydrogen peroxide (H2O2) synthesis. A carbon nanotubes (CNTs) hybrid with covalently attached C60 onto the outer surface of CNTs can be synthesized. The structure of C60-CNT hybrid can be confirmed by physical and chemical characterizations and its conformation is proposed featuring the covalent incorporation of CNTs and C60 derivative. C60-CNT hybrid shows high efficiencies on electro-generating H2O2, owing to huge surface area and intermolecular electron-transfer in the hybrid structure. A high H2O2 production rate of 4834.57 mgL-1 h-1 (426.58 mmol L-1) was achieved at −0.2 V vs saturated calomel electrode (SCE).

A system, apparatus or method that produces carbon allotropes either fullerenes and/or their derivatives, to replace the existing shortage of, dolomite, dolomitized limestone, and, or carbon black replacement during the process of asphalt concrete mixing as binding agent, to increase thermal performance and road rigidity.

A system, apparatus or method that produces carbon allotropes either fullerenes and/or their derivatives, which is already functionalized, or partially functionalized.

A system, apparatus or method that produces carbon allotropes either fullerenes and/or their derivatives, that are used to fuel a reaction to create hydrogen.

A system, apparatus or method that produces carbon allotropes either fullerenes and/or their derivatives, as a means the transport of a chemical compound into a site to produce a desired effect. These materials act as carriers because they show good biocompatibility, selectivity and they are still small enough for the right diffusion in an organism, which is needed for their final localization. In the case of gene delivery, foreign DNA is introduced into the cells, which achieves desired effect. For this purpose, DNA sequences are connected with amino acid derivatives of C60. In the proper site, these sequences are disconnected by loss or denaturation of these amino groups. Biochemical experiments have revealed better abilities compared to vectors which are commonly used for this application.

A system, apparatus or method that produces rare earths, from coal, metal tailing ponds, electronic waste, and oil sand waste ponds, to be separated, simultaneously. As an alternative to rare earth mining and shortages.

A system, apparatus or method that produces carbon allotropes either fullerenes and/or their derivatives, to manage waste materials.

A system, apparatus or method that recovers elemental metals from metal refinery oxides for metal recovery from melt losses in refining. Typical losses from refining gold are 1%-2.5% from melt or mass losses and another 1.5%-2.5% on assay or under carat losses. Typical losses from refining silver are 2%-4.5% from melt or mass losses and another 2.5%-7.5% on assay or under carat losses.

A system, apparatus or method that produces carbon allotropes either fullerenes and/or their derivatives, to produce a carbon fuel or synfuel for combustion (e.g., heating value>29 MJ/kg, possible replacement fuel for coal plants).

A system, apparatus or method that produces carbon allotropes either fullerenes and/or their derivatives, to produce a carbon fuel via pyrolysis of carbon allotropes and further processing into renewable fuels and chemicals.

A system, apparatus or method that produces carbon allotropes either fullerenes and/or their derivatives, to produce a carbon fuel for uses as an agricultural soil amendment or is coated onto a biochar to increase its effectiveness in soils.

A system, apparatus or method that produces carbon allotropes either fullerenes and/or their derivatives, for water treatment and to deacidification.

A system, apparatus or method that produces carbon allotropes either fullerenes and/or their derivatives, where material is blended with biomass as a fuel for biomass plant.

A system, apparatus or method that produces carbon allotropes either fullerenes and/or their derivatives, from marine ship emissions.

A system, apparatus or method that produces carbon allotropes either fullerenes and/or their derivatives, is used to produce commercial wood substitute products for fireplaces, and wood stoves, by mixing it with a binder and forming it into either pellets or logs.

A system, apparatus or method that produces carbon allotropes either fullerenes and/or their derivatives, as adsorbent of nitrogen fertilizers to increase ammonia valorization.

A system, apparatus or method that produces carbon allotropes either fullerenes and/or their derivatives, for oxygen or other gaseous storage.

A system, apparatus or method that produces carbon allotropes either fullerenes and/or their derivatives, for oxygen storage, oxygen enhanced carbon fuel as replacement for coal and biomass.

A system, apparatus or method that produces carbon allotropes either fullerenes and/or their derivatives, to convert vegetable oil to fullerenes.

A system, apparatus or method that produces carbon allotropes either fullerenes and/or their derivatives, for urea coating.

A system, apparatus or method that produces carbon allotropes either fullerenes and/or their derivatives, for a manure additive for soil amendments.

A system, apparatus or method that produces carbon allotropes either fullerenes and/or their derivatives, as well as allotropes of sulfur if SO2 is present in the feed gas allowing for a modification of the Claus process.

A system, apparatus or method that produces carbon allotropes either fullerenes and/or their derivatives, to manage CO2 gas separated from biogas.

A system, apparatus or method that produces carbon allotropes either fullerenes and/or their derivatives, to manage gas separated from pyrolysis units.

A system, apparatus or method that produces carbon allotropes either fullerenes and/or their derivatives, adding grip to soles of shoes.

A system, apparatus or method that produces carbon allotropes either fullerenes and/or their derivatives, to synthesize photocatalysts (e.g., C3N4).

A system, apparatus or method that produces carbon allotropes either fullerenes and/or their derivatives, to provide additives to produce fuels, synfuels and/or biofuels.

A system, apparatus or method that produces carbon allotropes either fullerenes and/or their derivatives, for fuel cell electrodes.

A system, apparatus or method that produces carbon allotropes either fullerenes and/or their derivatives to produce compact EMF/RF shielding packaging.

A system, apparatus or method that produces carbon allotropes either fullerenes and/or their derivatives as Carbon nanotubes (CNTs). CNTs are materials with exceptional electrical, thermal, mechanical, and optical properties. Ever since it was demonstrated that they also possess interesting thermoelectric properties, they have been considered a promising solution for thermal energy harvesting as a dopant.

A system, apparatus or method that produces a significant reduction in atmospheric oxidized air resulting in an increase in plant growth and yield by up to 30%.

A system, apparatus or method that produces a terra-formed atmosphere by dissociation of oxides into elemental forms, which significantly removes mold, fungus, pot rot, bacteria and viruses from the atmosphere allowing plants to dedicate energy to growth and crop productivity.

A system, apparatus or method that produces enhanced cannabinoid/terpenoid COAs. Bud size/weight and COA's compared with the same or similar strains.

A system, apparatus or method that produces enhanced air quality and eliminates surface contamination in human & animal dwellings for transmission of airborne and contact transmission from viruses and Bacteria.

A system, apparatus or method that produces enhanced vitamin and nutritional values in vegetables and fruits during the growing of these in green houses.

A system, apparatus or method that produces carbon allotropes either fullerenes specifically nanotubes for the production of IC transistors.

A system, apparatus or method that produces carbon allotropes either fullerenes or nanotubes which include Nitrogen, Boron, and other elemental elements for synthesis of novel new materials.

A system, apparatus or method that is able to isolate and separate radioactive isotopes oxides from contaminated water.

A system, apparatus or method that is able to isolate and separate MgO, Cu2S, CuO, H2S, Mg(OH)2, ZnS into elemental form.

A system, apparatus or method that is able to form carbon materials that, when mixed with sand, act as a lubricant. This should increase penetration into cracks in the rock as it would act as a lubricant with the sand.

A system, apparatus or method that is able to form allotropes of carbon that can be mixed with putty to produce a conformal thermally conductive Material for matting to irregular hot surfaces to act as a thermal or electrical pathway for thermoelectric power Generators.

A system, apparatus or method that is able to form allotropes of carbon that can be mixed with asphalt to provide added strength for roads and bridges and potential electrical contacts for heating of surfaces to reduce deicing, salting requirements. Particularly for bridges and walk ways.

A system, apparatus or method that produces carbon allotropes either fullerenes and/or their derivatives, to produce a contrast material coupled with barium or iodine, for radiological purposes.

A system, apparatus or method that produces carbon allotropes either fullerenes and/or their derivatives, to produce a carbon material for intercalation of elements, (i.e. Mg, Ba, Al) to produce electrodes, cathodes, anodes, batteries, and other electronic applications.

A system, apparatus or method that produces carbon allotropes either fullerenes and/or their derivatives from the emissions of a power plant that can be combined with an existing scrubbing process that uses calcium compounds that react with sulfur oxides to form gypsum. To create a combine gypsum carbon product that is superior to gypsum.

Thus, the present invention can be described by the following non-limiting embodiments.

An apparatus for removing compounds from a fluid medium and converting at least some of the compounds to elemental substances comprises an electrode bed comprising a plurality of conductive electrode needles protruding from a surface of the electrode bed, where the electrode needles are coupled with a voltage source, a water overflow panel spaced from the electrode needles of the electrode bed and including a surface upon which, in operation, water flows, where the electrode needles extend toward the surface of the water overflow panel, and a reaction zone is defined as a space disposed between and separating the surface of the water overflow panel from the electrode needles protruding from the electrode bed. The apparatus further comprises a water supply that provides a flow of water into the reaction zone along the surface of the water overflow panel, a fluid supply including an inlet that provides a source fluid including impurities entrained in the fluid into the reaction zone and an exit that facilitates transport of purified fluid from the reaction zone, the purified fluid having less impurities entrained in the purified fluid in relation to the source fluid, and a power source to apply electrical energy to the electrode needles at a pulse frequency of greater than 24,000 Hertz (Hz) and a negative voltage of 30 kilovolts (kV) to 100 kV. In operation in which electrical energy is applied by the power source to the electrode needles, water from the water supply is flowed along the surface of the water overflow panel, and the source fluid is flowed through the reaction zone, impurities entrained in the source fluid are removed and converted to elemental components that become entrained in the water.

The apparatus can further comprise a housing that contains the electrode bed and the water overflow panel, where the water overflow panel and the electrode bed are arranged generally vertically and are angled in relation to a height dimension of the housing.

The apparatus can further comprise a pair of electrode beds and corresponding water overflow panels, where a first electrode bed and corresponding first water overflow panel are located at a first side of the housing, and a second electrode bed and corresponding second water overflow panel are located at a second side of the housing that opposes the first side.

The reaction zone can have a reaction zone width defined as a distance between the electrode needles of the electrode bed and a reaction surface of the water overflow panel that faces the electrode needles, and the reaction zone width varies along a length of the reaction zone. In addition, the reaction zone width can decrease in a direction of flow of the source fluid through the reaction zone.

The fluid supply can provide the source fluid into the reaction zone in a direction that opposes a direction in which the water supply provides water into the reaction zone.

The electrode needles of the electrode bed can be coated with a deposit material comprising one or more of nickel, tungsten, boron, copper and carbon. For example, the electrode needles of the electrode bed can be coated with a deposit material comprising nickel in an amount greater than 50% by weight of the deposit material, tungsten in an amount from 3% to 6% by weight of the deposit material, boron in an amount from 1% to 3% by weight of the deposit material, copper in an amount from 0.5% to 1% by weight of the deposit material, and carbon in an amount from 1% to 3.5% by weight of the deposit material.

The elemental components can comprise one or more elements selected from the group consisting of carbon, sulfur, nitrogen, lead, iron and zinc. For example, the elemental components can comprise allotropes of carbon and/or sulfur.

The surface of the electrode bed can be planar and/or the surface of the water overflow plane is planar.

A system can further be provided including the apparatus described herein.

In example embodiments a system comprises a housing, and a plurality of apparatuses disposed within the housing, each apparatus comprising an electrode bed disposed comprising a plurality of conductive electrode needles protruding from a surface of the electrode bed, where the electrode needles are coupled with a voltage source, and a water overflow panel spaced from the the electrode bed and including a surface upon which, in operation, water flows along the water overflow panel, where the electrode needles extend toward the surface of the water overflow panel, and a reaction zone is defined at a space disposed between and separating the surface of the water overflow panel and the electrode needles protruding from the electrode bed. The system further comprises a water supply that recirculates a flow of water along the surface of the water overflow panel for each apparatus within the housing, the water supply further including a reservoir that separates compounds and/or elemental materials from the water prior to recirculating the water to the surface of the water overflow panel for each apparatus within the housing, and a fluid supply that provides a source fluid including impurities entrained in the fluid into an inlet of each apparatus within the housing for delivery to the reaction zone and for processing of the fluid by each apparatus within the housing. The system further comprises a purified fluid delivery structure that receives processed and purified fluid from the reaction zone of each apparatus within the housing and facilitates transport of the processed and purified fluid out of the housing. In operation in which a voltage source is applied to the electrode needles, water from the water supply is flowed along the surface of the water overflow panel, and source fluid is flowed through the reaction zone, impurities entrained in the source fluid are removed and converted to elemental components that become entrained in the water and are separated from the water in the reservoir.

In the system, the apparatuses can be arranged in parallel with regard to flow of the source fluid to the apparatuses within the housing. The apparatuses can also be arranged in series with regard to flow of source fluid to the apparatuses within the housing.

Each apparatus within the housing can further comprise a pair of electrode beds and corresponding water overflow panels, where a first electrode bed and corresponding first water overflow panel of each apparatus are located at a first side of the apparatus, and a second electrode bed and corresponding second water overflow panel of each apparatus are located at a second side of the apparatus that opposes the first side.

The system can further comprise an air curtain structure that forces air toward the inlet of each apparatus at which source fluid is provided by the fluid supply so as to direct the source fluid toward the first and second sides of each apparatus and into each reaction zone located between the first electrode bed and the corresponding first water overflow panel of each apparatus and the second electrode bed and the corresponding second water overflow panel of each apparatus.

In further example embodiments, a method of removing compounds from a fluid medium and converting at least some of the compounds to elemental substances comprises directing water to flow along a surface of a water overflow panel within an apparatus, applying electrical energy to a plurality of conductive electrode needles protruding from a plane of an electrode bed, where the electrode bed is aligned with the water overflow panel such that the electrode needles extend toward the surface of the water overflow panel, and a reaction zone is defined at a space disposed between and separating the surface of the water overflow panel and the electrode needles protruding from the electrode bed, and directing a source fluid into the reaction zone defined between the surface of the water overflow panel and the electrode needles protruding from the electrode bed while electrical energy is applied to the electrode needles at a pulse frequency of greater than 24,000 Hertz (Hz) and a negative voltage of 30 kilovolts (kV) to 100 kV so as to remove impurities entrained in the source fluid and convert the removed impurities to elemental components that become entrained in the water flowing along the surface of the water overflow panel.

In the method, the elemental components can comprise one or more elements selected from the group consisting of carbon, sulfur, nitrogen, lead, iron and zinc. For example, the elemental components can comprise allotropes of carbon and/or sulfur.

The method can further comprise forming hydroxyl radicals along with elemental components during directing of the source fluid into the reaction zone while electrical energy is applied to the electrode needles.

In the method, the electrical energy can be further applied at a pulse frequency ranging from 0.1 MHz to 10 MHz.

In the method, the surface of the electrode bed can be planar and/or the surface of the water overflow plane is planar.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

It is intended that the present invention covers the modifications and variations of this invention provided they come within the scope of the appended claims and their equivalents. It is to be understood that terms such as “top”, “bottom”, “front”, “rear”, “side”, “height”, “length”, “width”, “upper”, “lower”, “interior”, “exterior”, and the like as may be used herein, merely describe points of reference and do not limit the present invention to any particular orientation or configuration.

What is claimed:

1. An apparatus for removing compounds from a fluid medium and converting at least some of the compounds to elemental substances, the apparatus comprising:
an electrode bed comprising a plurality of conductive electrode needles protruding from a surface of the electrode bed, wherein the electrode needles are coupled with a voltage source;
a water overflow panel spaced from the electrode needles of the electrode bed and including a surface upon which, in operation, water flows, wherein the electrode needles extend toward the surface of the water overflow panel, and a reaction zone is defined as a space disposed between and separating the surface of the water overflow panel from the electrode needles protruding from the electrode bed;
a water supply that provides a flow of water into the reaction zone along the surface of the water overflow panel;
a fluid supply including an inlet that provides a source fluid including impurities entrained in the fluid into the reaction zone and an exit that facilitates transport of purified fluid from the reaction zone, the purified fluid having less impurities entrained in the purified fluid in relation to the source fluid; and
a power source to apply electrical energy to the electrode needles at a pulse frequency of greater than 24,000 Hertz (Hz) and a negative voltage of 30 kilovolts (kV) to 100 kV;
wherein, in operation in which electrical energy is applied by the power source to the electrode needles, water from the water supply is flowed along the surface of the water overflow panel, and the source fluid is flowed through the reaction zone, impurities entrained in the source fluid are removed and converted to elemental components that become entrained in the water.

2. The apparatus of claim 1, further comprising a housing that contains the electrode bed and the water overflow panel, wherein the water overflow panel and the electrode bed are arranged generally vertically and are angled in relation to a height dimension of the housing.

3. The apparatus of claim 2, further comprising a pair of electrode beds and corresponding water overflow panels, wherein a first electrode bed and corresponding first water overflow panel are located at a first side of the housing, and a second electrode bed and corresponding second water overflow panel are located at a second side of the housing that opposes the first side.

4. The apparatus of claim 1, wherein the reaction zone has a reaction zone width defined as a distance between the electrode needles of the electrode bed and a reaction surface of the water overflow panel that faces the electrode needles, and the reaction zone width varies along a length of the reaction zone.

5. The apparatus of claim 4, wherein the reaction zone width decreases in a direction of flow of the source fluid through the reaction zone.

6. The apparatus of claim 1, wherein the fluid supply provides the source fluid into the reaction zone in a direction that opposes a direction in which the water supply provides water into the reaction zone.

7. The apparatus of claim 1, wherein the electrode needles of the electrode bed are coated with a deposit material comprising one or more of nickel, tungsten, boron, copper and carbon.

8. The apparatus of claim 1, wherein the electrode needles of the electrode bed are coated with a deposit material comprising nickel in an amount greater than 50% by weight of the deposit material, tungsten in an amount from 3% to 6% by weight of the deposit material, boron in an amount from 1% to 3% by weight of the deposit material, copper in an amount from 0.5% to 1% by weight of the deposit material, and carbon in an amount from 1% to 3.5% by weight of the deposit material.

9. The apparatus of claim 1, wherein the elemental components comprise one or more elements selected from the group consisting of carbon, sulfur, nitrogen, lead, iron and zinc.

10. The apparatus of claim 9, wherein the elemental components comprise allotropes of carbon and/or sulfur.

11. The apparatus of claim 1, wherein the surface of the electrode bed is planar and/or the surface of the water overflow plane is planar.

12. A system comprising the apparatus of claim 1.

13. A system comprising:
a housing;
a plurality of apparatuses disposed within the housing, each apparatus comprising:
an electrode bed disposed comprising a plurality of conductive electrode needles protruding from a surface of the electrode bed, wherein the electrode needles are coupled with a voltage source; and
a water overflow panel spaced from the electrode bed and including a surface upon which, in operation, water flows along the water overflow panel, wherein the electrode needles extend toward the surface of the water overflow panel, and a reaction zone is defined at a space disposed between and separating the surface of the water overflow panel and the electrode needles protruding from the electrode bed;
a water supply that recirculates a flow of water along the surface of the water overflow panel for each apparatus within the housing, the water supply further including a reservoir that separates compounds and/or elemental materials from the water prior to recirculating the water to the surface of the water overflow panel for each apparatus within the housing; and
a fluid supply that provides a source fluid including impurities entrained in the fluid into an inlet of each apparatus within the housing for delivery to the reaction zone and for processing of the fluid by each apparatus within the housing; and
a purified fluid delivery structure that receives processed and purified fluid from the reaction zone of each apparatus within the housing and facilitates transport of the processed and purified fluid out of the housing;
wherein, in operation in which a voltage source is applied to the electrode needles, water from the water supply is flowed along the surface of the water overflow panel, and source fluid is flowed through the reaction zone, impurities entrained in the source fluid are removed and converted to elemental components that become entrained in the water and are separated from the water in the reservoir.

14. The system of claim 13, wherein the apparatuses are arranged in parallel with regard to flow of the source fluid to the apparatuses within the housing.

15. The system of claim 13, wherein the apparatuses are arranged in series with regard to flow of source fluid to the apparatuses within the housing.

16. The system of claim 13, wherein each apparatus within the housing further comprises a pair of electrode beds and corresponding water overflow panels, wherein a first electrode bed and corresponding first water overflow panel of each apparatus are located at a first side of the apparatus, and a second electrode bed and corresponding second water overflow panel of each apparatus are located at a second side of the apparatus that opposes the first side.

17. The system of claim 16, further comprising:
an air curtain structure that forces air toward the inlet of each apparatus at which source fluid is provided by the fluid supply so as to direct the source fluid toward the first and second sides of each apparatus and into each reaction zone located between the first electrode bed and the corresponding first water overflow panel of each apparatus and the second electrode bed and the corresponding second water overflow panel of each apparatus.

18. A method of removing compounds from a fluid medium and converting at least some of the compounds to elemental substances, the method comprising:
directing water to flow along a surface of a water overflow panel within an apparatus;
applying electrical energy to a plurality of conductive electrode needles protruding from a plane of an electrode bed, wherein the electrode bed is aligned with the water overflow panel such that the electrode needles extend toward the surface of the water overflow panel, and a reaction zone is defined at a space disposed between and separating the surface of the water overflow panel and the electrode needles protruding from the electrode bed; and
directing a source fluid into the reaction zone defined between the surface of the water overflow panel and the electrode needles protruding from the electrode bed while electrical energy is applied to the electrode needles at a pulse frequency of greater than 24,000 Hertz (Hz) and a negative voltage of 30 kilovolts (kV) to 100 kV so as to remove impurities entrained in the source fluid and convert the removed impurities to elemental components that become entrained in the water flowing along the surface of the water overflow panel.

19. The method of claim 18, wherein the elemental components comprise one or more elements selected from the group consisting of carbon, sulfur, nitrogen, lead, iron and zinc.

20. The method of claim 18, wherein the elemental components comprise allotropes of carbon and/or sulfur.

21. The method of claim 18, further comprising forming hydroxyl radicals along with elemental components during directing of the source fluid into the reaction zone while electrical energy is applied to the electrode needles.

22. The method of claim 18, wherein the electrical energy is further applied at a pulse frequency ranging from 0.1 MHz to 10 MHz.

23. The method of claim 18, wherein the surface of the electrode bed is planar and/or the surface of the water overflow plane is planar.
